(19) United States
(12) Patent Application Publication
(10) Pub. No.: US 2023/0305828 A1
(43) Pub. Date: Sep. 28, 2023

(54) VIRTUAL UPGRADE LAYER-BASED APPLICATION UPGRADE

(71) Applicant: VMWARE, INC., Palo Alto, CA (US)

(72) Inventors: AMIT BABURAO GUJAR, Pune (IN); TRISHAL RATNAKAR CHOUDHARI, Pune (IN)

(21) Appl. No.: 17/702,833

(22) Filed: Mar. 24, 2022

(51) Int. Cl. G06F 8/65; G06F 8/61; G06F 3/06

(52) U.S. Cl. CPC G06F 8/65; G06F 8/61; G06F 3/0604; G06F 3/0652; G06F 3/067; G06F 3/0679

(57) ABSTRACT

Example system includes application hosts with each application host executing an application and a management node coupled to the plurality of application hosts via a network. The management node includes an application upgrade unit to install an upgrade agent in each application host requiring an upgrade of the application. Further, management node may execute the upgrade agent to create a virtual upgrade layer in a non-volatile storage device of each application host. The upgrade agent may copy an application upgrade package and application data associated with the application to the virtual upgrade layer. Further, the upgrade agent may upgrade the application in the virtual upgrade layer of each application host using the application upgrade package and the application data. In response to receiving a go-live command, the upgrade agent may commit the upgraded application from the virtual upgrade layer to the non-volatile storage device of each application host.

### TECHNICAL FIELD

The present disclosure relates to computing environments, and more particularly to methods, techniques, and systems for upgrading an application host in a computing environment using a virtual upgrade layer.

### BACKGROUND

In a software-defined data center (“SDDC”), infrastructure elements are virtualized and delivered as a service. Networking, storage, processing, and security functions can execute as virtualized components on top of physical hardware devices, such as servers. An SDDC can span one or more clouds. By virtualizing aspects of a regular data center, the SDDC can allow for easier and more flexible deployments that scale according to enterprise or client needs.

SDDCs may require continual updating of various software components within the SDDC. This process is generally referred to as lifecycle management or lifecycle orchestration. Different components of the SDDC can include different types of software, therefore requiring different upgrade packages. However, as various software components of the SDDC sometimes work together, upgrading a component can break compatibility with another component. Further, an SDDC administrator may have to study and manage component dependencies in order to upgrade components in a manner that retains compatibility with other components. Further, the incompatibility issues may arise when only few servers are upgraded from a group of servers. For example, consider an SDDC having 10 production servers. In this example, performing upgrade of 4 servers at a first stage and scheduling the upgrade of the remaining 6 servers at a later stage may result in incompatibility/inconsistency issues which may in turn lead to failure in the production environment. Therefore, the administrator may have to make sure that all the servers are upgraded at a same time, which is sometimes unfeasible. As the number of components and available versions increase, the task of managing upgrades can become overwhelming, which can result in decreased efficiency, outdated software, and broken SDDC systems.

### BRIEF DESCRIPTION OF THE DRAWINGS

FIG. 1 is a block diagram of an example system, depicting a management node to upgrade applications in application hosts;

FIG. 2A is a flowchart illustrating an example method for upgrading an application in an application host;

FIG. 2B is a continuation of flowchart of FIG. 2A, illustrating the example method for upgrading the application in the application host;

FIG. 2C is a flowchart illustrating an example method for deleting a virtual upgrade layer from a non-volatile storage device;

FIGS. 3A-3D are schematic block diagrams of an example application host, illustrating a sequence of operations for upgrading an application;

FIG. 4 is a schematic block diagram of an example system, depicting a management node to upgrade an application on a plurality of application hosts;

FIG. 5 is a flowchart illustrating another example method for upgrading an application in an application host; and

FIG. 6 is a block diagram of an example management node including a non-transitory computer-readable storage medium storing instructions to upgrade an application in each of a plurality of application hosts.

The drawings described herein are for illustration purposes only and are not intended to limit the scope of the present subject matter in any way.

### DETAILED DESCRIPTION

The paragraphs [0013] and [0014] are an overview of applications running in computing environments, existing methods to upgrade the applications, and drawbacks associated with the existing methods. Computing environment may be a physical computing environment (e.g., an on-premises enterprise computing environment), a virtual computing environment (e.g., a cloud computing environment, a virtualized environment, and the like) or a hybrid of both. The virtual computing environment may be a pool or collection of cloud infrastructure resources designed for enterprise needs. The resources may be a processor (e.g., central processing unit (CPU)), memory (e.g., random-access memory (RAM)), storage (e.g., disk space), and networking (e.g., bandwidth). Further, the virtual computing environment may be a virtual representation of a physical data center, complete with servers, storage clusters, and networking components, all of which may reside in virtual space being hosted by one or more physical data centers. The virtual computing environment may include multiple physical computers executing different computing-instances or workloads (e.g., virtual machines (VMs), virtual appliances, template, and the like). The workloads may execute different types of applications.

A software defined data center (SDDC) infrastructure can include different software-based systems that are used for the overall implementation and operation of the virtual computing environment for an enterprise. Software defined data centers may include different applications to manage different aspects of the data center. One implementation of the virtualized computing environment can include a life cycle manager that can manage the deployment, upgrades, and configuration of the different applications/services. As upgrades and patches become available for services/applications installed on application hosts (e.g., physical computers, virtual machines, or the like) within the data center, data center operators can request an upgrade of the installed services/applications. However, due to possible dependencies between different services/applications, complications can occur when one of the services/applications is upgraded prior to other services/applications. Such application upgrades may result in incompatibility or inconsistency issues, for instance, when an application upgrade is performed on only few servers from a group of servers. Such inconsistency issues could result in inoperability of one or more of the services/applications which can affect the overall operation of the data center. Also, performing an application upgrade on all the application hosts at a same time may not be feasible.

Examples described herein may provide an enhanced computer-based and/or network-based method, technique, and system to upgrade application hosts in a computing environment using a virtual upgrade layer. Examples described herein may provide a system including a plurality of application hosts with each application host executing an application and a management node coupled to the plurality of application hosts via a network, The management node may enable users to upgrade applications on application hosts at their own time and trigger a go-live command once the application upgrade is completed on all the application hosts. In an example, the management node may create a virtual upgrade layer in a non-volatile storage device of each application host requiring an application upgrade. Further, the management node may copy an application requiring the application upgrade, residing in the non-volatile storage device and a volatile storage device, to the virtual upgrade layer of each application host. Furthermore, the management node may copy the application upgrade package to the virtual upgrade layer of each application host. Also, the management node may upgrade the application in the virtual upgrade layer of each application host using the application upgrade package and the application data.

Upon completion of upgrading the application in the virtual upgrade layer of each application host and in response to receiving a go-live command, the management node may commit the upgraded application from the virtual upgrade layer to the non-volatile storage device of each application host and start running the upgraded application in each application host. Thus, examples described herein may enable the users to upgrade the application hosts (e.g., production servers) as per their timeline and assist in avoiding incompatibility/inconsistency issues due to different software versions, thereby providing a seamless application upgrade experience.

In the following description, for purposes of explanation, numerous specific details are set forth to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

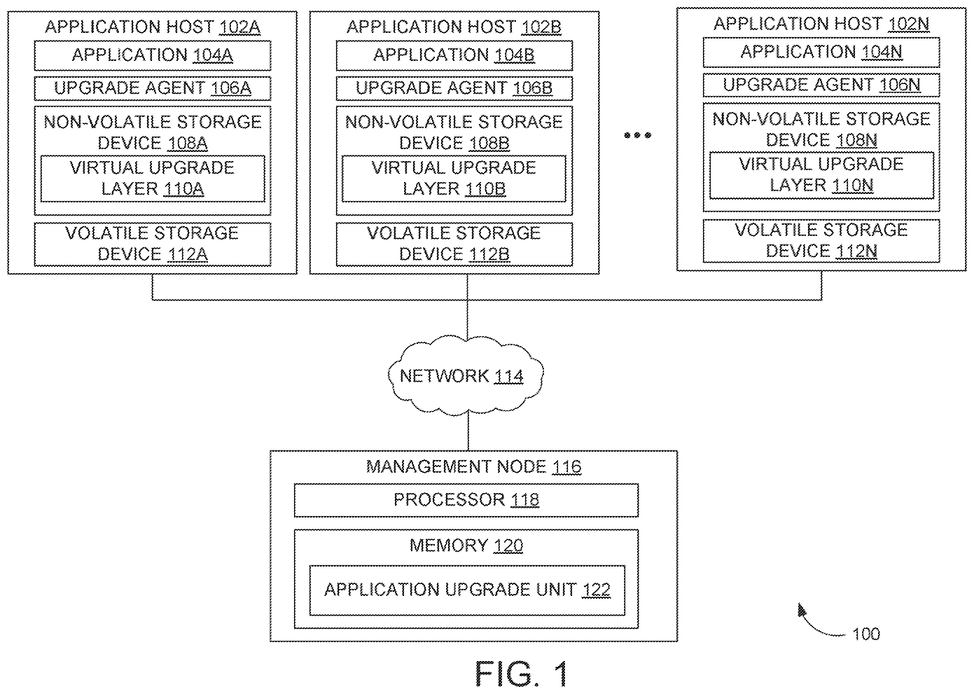

Turning now to the figures, FIG. 1 is a block diagram of an example system 100, depicting a management node 116 to upgrade applications 104A-104N in respective application hosts 102A-102N. Example system 100 may be a cloud computing environment. For example, the cloud computing environment may be enabled by vSphere®, VMware's cloud computing virtualization platform. Further, example system 100 may include multiple data centers. A data center may be a physical data center (e.g., an on-premises enterprise computing environment) and/or a virtual data center (e.g., a cloud computing environment, a virtualized environment, or the like). For example, the physical data center may include one or more physical host computing devices (e.g., servers), each of which may be configured to execute one or more applications. In another example, a number of virtual data centers may be deployed within the physical data center using virtual machines. The virtual data center may be a pool or collection of cloud infrastructure resources designed for enterprise needs. Furthermore, the virtual data center may be a virtual representation of the physical data center, complete with servers, storage clusters and networking components, all of which may reside in a virtual space being hosted by one or more physical data centers.

As shown in FIG. 1, system 100 includes a plurality of application hosts 102A-102N. For example, application hosts 102A-102N may include physical host computing devices, virtual machines, or a combination thereof. A physical host computing device may be a hardware-based device (e.g., a personal computer, a laptop, and the like) including an operating system (OS). The virtual machine may operate with its own guest OS on the physical host computing device using resources of the physical computer virtualized by virtualization software (e.g., a hypervisor, a virtual machine monitor, and the like). In some examples, each of application hosts 102A-102N may execute corresponding applications 104A-104N. An example application, also referred to as an application program or application software, may be a computer software package that performs a specific function directly for an end user or, in some cases, for another application. Examples of applications may include MySQL, Tomcat, Apache, word processors, database programs, web browsers, development tools, image editors, communication platforms, and the like.

Further, each of application hosts 102A-102N includes a corresponding one of non-volatile storage devices 108A-108N and a corresponding one of volatile storage devices 112A-112N. A non-volatile storage device may refer to physical media that retains data without electrical power, i.e., no data is lost when an application host is powered off, making the non-volatile storage device suitable for permanent storage of information. An example non-volatile storage device may include read-only memory (ROM), flash memory, magnetic computer storage devices (e.g., hard disks, floppy disks, and the like), and the like. A volatile storage device may refer to a computer storage that only maintains data while an application host is powered on. An example volatile storage device may include a random-access memory (RAM) or another type of dynamic storage device. The volatile storage device may be used as a main memory or primary memory while the non-volatile storage device may be used as a secondary memory in each of application hosts 102A-102N.

Furthermore, system 100 includes management node 116 in communication with plurality of application hosts 102A-102N via a network 114. Example network 114 can be a managed Internet protocol (IP) network administered by a service provider. For example, network 114 is implemented using wireless protocols and technologies, such as WiFi, WiMax, and the like. In other examples, network 114 can also be a packet-switched network such as a local area network, wide area network, metropolitan area network, Internet network, or other similar type of network environment. In yet other examples, network 114 is a fixed wireless network, a wireless local area network (LAN), a wireless wide area network (WAN), a personal area network (PAN), a virtual private network (VPN), intranet or other suitable network system and includes equipment for receiving and transmitting signals.

Further, management node 116 includes a processor 118 and a memory 120 coupled to processor 118. The term “processor” may refer to, for example, a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. Processor 118 may, for example, include single or multiple cores on a chip, multiple cores across multiple chips, multiple cores across multiple devices, or suitable combinations thereof. Processor 118 may be functional to fetch, decode, and execute instructions as described herein.

In other examples, management node 116 may be implemented as software program running on a physical computer or a virtual computer. Example management node 116 may be a VMware® vCenter™ server with at least some of the features available for such server. Memory 120 may include an application upgrade unit 122. During operation, application upgrade unit 122 may install an upgrade agent (e.g., 106A-106N) in each of the application hosts 102A-102N requiring an upgrade of a respective application 104A-104N. Upon installing upgrade agents 106A-106N, application upgrade unit 122 may execute upgrade agents 106A-106N. In an example, upgrade agents 106A-106N, when executed, may create a virtual upgrade layer (e.g., 110A-110N) in a respective non-volatile storage device 108A-108N of each application host 102A-102N. A virtual upgrade layer (e.g., 110A-110N) may refer to a memory partition, in corresponding non-volatile storage devices 108A-108N of application hosts 102A-102N, that is used to isolate an application upgrade event from other events or processes running in application hosts 102A-102N.

Further, each of upgrade agents 106A-106N may copy an application upgrade package and application data associated with applications 104A-104N to corresponding virtual upgrade layers 110A-110N. An example application upgrade bundle can define individual service upgrades associated with an overall upgrade of a software-based system of a virtualized computing environment. When a system (e.g., application host 102A) or portion of the system is to be upgraded, the application upgrade bundle can include a list of service upgrades associated with the system upgrade. In an example, application upgrade unit 122 may push the application upgrade package to each application host 102A-102N requiring the upgrade for storing in corresponding non-volatile storage devices 108A-108N of each application host 102A-102N. Further, upgrade agents 106A-106N, when executed, may copy the application upgrade package from corresponding non-volatile storage devices 108A-108N to virtual upgrade layers 110A-110N of each application host 102A-102N. In another example, upgrade agents 106A-106N, when executed, may obtain the application upgrade package directly from an application server and store the application upgrade package in corresponding virtual upgrade layers 110A-110N of each application host 102A-102N.

In an example, upgrade agents 106A-106N may copy the application data associated with applications 104A-104N requiring the upgrade, residing in corresponding non-volatile storage devices 108A-108N and volatile storage devices 112A-112N, to virtual upgrade layers 110A-110N of respective application hosts 102A-102N.

Furthermore, upgrade agents 106A-106N may upgrade applications 104A-104N in virtual upgrade layers 110A-110N of respective application hosts 102A-102N using the application upgrade package and the application data. In an example, upgrade agents 106A-106N may upgrade applications 104A-104N in respective virtual upgrade layers 110A-110N of each application host 102A-102N as a background process while respective applications 104A-104N are running in each application host 102A-102N. In this example, an upgrade agent (e.g., upgrade agent 106A) may isolate an application upgrade event only to a virtual upgrade layer (e.g., virtual upgrade layer 110A) of an application host (e.g., application host 102A). Thus, application upgrade unit 122 may enable users to upgrade applications 104A-104N in respective virtual upgrade layers 110A-110N of each application host 102A-102N at their own time while corresponding application 104A-104N is running in each application host 102A-102N.

Further, in response to receiving a go-live command, upgrade agents 106A-106N may commit the upgraded application from virtual upgrade layers 110A-110N to respective non-volatile storage devices 108A-108N of each application host 102A-102N. For example, a user may trigger the go-live command upon the completion of upgrading applications 104A-104N in virtual upgrade layers 110A-110N of each application host 102A-102N requiring the upgrade, for instance, via application upgrade unit 122. In an example, in response to receiving the go-live command, each upgrade agent 106A-106N may:
halt applications 104A-104N running in respective volatile storage devices 112A-112N of each application host 102A-102N,
uninstall applications 104A-104N from respective non-volatile storage devices 108A-108N,
move the upgraded application from respective virtual upgrade layer 110A-110N to non-volatile storage device 108A-108N, and
start running the upgraded application in respective volatile storage devices 112A-112N of each application host 102A-102N.

Thus, application upgrade unit 122 may commit the upgraded application to ensure that all application hosts 102A-102N requiring the upgrade are upgraded at a same time. In an example, upon committing the upgraded application from virtual upgrade layer 110A-110N to respective non-volatile storage devices 108A-108N, upgrade agents 106A-106N may output a prompt seeking user confirmation to determine a working status of the upgraded application (e.g., whether the application upgrade is successful, whether the upgraded application is working without any error, or the like). Further, when the upgraded application is working, upgrade agents 106A-106N may move the upgraded application from virtual upgrade layers 110A-110N to respective non-volatile storage devices 108A-108N and delete virtual upgrade layers 110-110N from non-volatile storage devices 108A-108N, respectively.

In another example, application upgrade unit 122 may generate a pre-upgrade snapshot of applications 104A-104N in each application host 102A-102N prior to installing upgrade agents 106A-106N. For example, application upgrade unit 122 may enable the users to back-up the application data prior to initiating the application upgrade process. When the upgraded application is not working, upgrade agents 106A-106N may revert respective application hosts 102A-102N to the pre-upgrade snapshot of applications 104A-104N (i.e., revert to a previous version of the applications 104A-104N using the back-up application data).

In some examples, the functionalities described in FIG. 1, in relation to instructions to implement functions of application upgrade unit 122, upgrade agents 106A-106N, and any additional instructions described herein in relation to the storage medium, may be implemented as engines or modules including any combination of hardware and programming to implement the functionalities of the modules or engines described herein. The functions of application upgrade unit 122 and upgrade agents 106A-106N may also be implemented by a respective processor. In examples described herein, the processor may include, for example, one processor or multiple processors included in a single device or distributed across multiple devices.

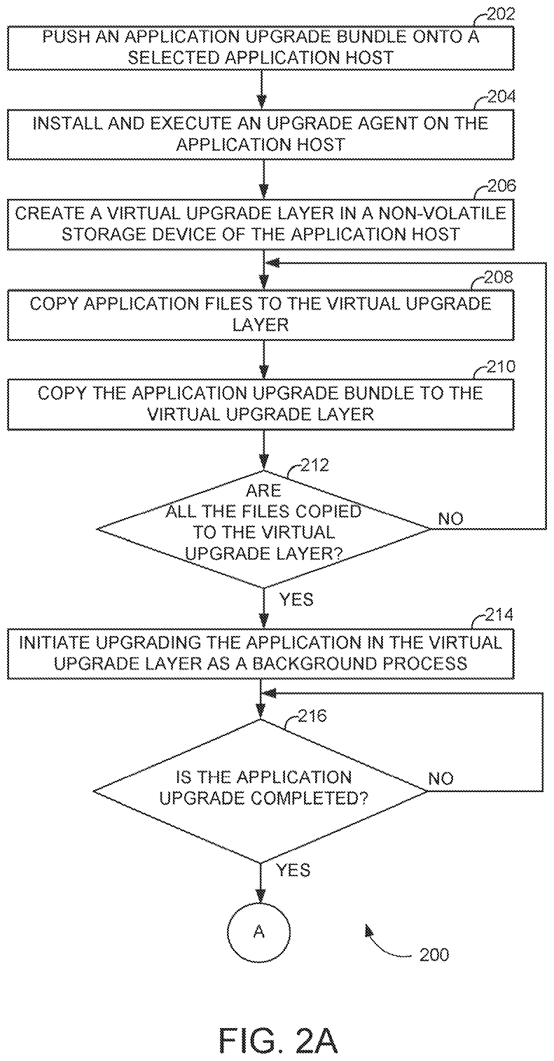

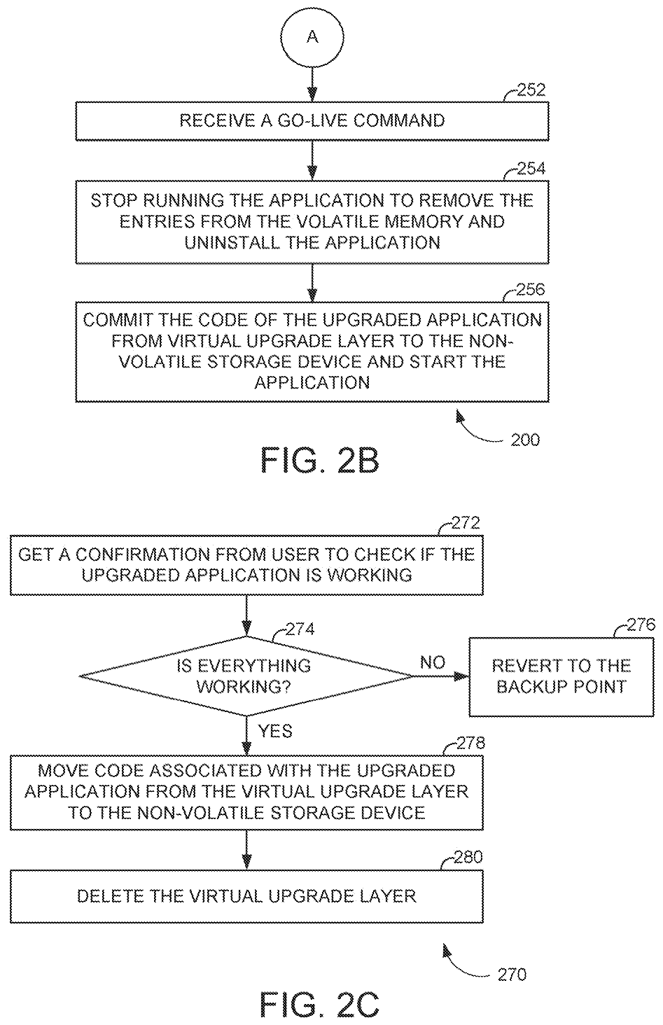

FIG. 2A is a flowchart illustrating an example method 200 for upgrading an application in an application host. At 202, an application upgrade bundle may be pushed onto a selected application host that requires an application upgrade. At 204, an upgrade agent may be installed and executed on the selected application host. At 206, a virtual upgrade layer may be created in a non-volatile storage device of the application host by the upgrade agent.

At 208, application files may be copied from the non-volatile storage device and the volatile storage device to the virtual upgrade layer by the upgrade agent. At 210, the application upgrade bundle may be copied from the non-volatile storage device to the virtual upgrade layer by the upgrade agent.

At 212, a check may be made to determine whether all the files corresponding to the application are copied to the virtual upgrade layer. When all the files of the application are not copied, the process goes to block 208 to repeat the step of copying the files of the application until all the files are copied. When all the files are copied, at 214, upgrading of the application in the virtual upgrade layer may be initiated by the upgrade agent as a background process. At 216, a check may be made to determine whether upgrading of the application is completed. When the upgrading of the application is completed, a process described in FIG. 2B may be implemented to commit code of the upgraded application.

FIG. 2B is a continuation of flowchart of FIG. 2A, illustrating example method 200 for upgrading the application in the application host. At 252, a go-live command may be received by the upgrade agent via a management application. In response to receiving the go-live command, at 254, the application running in a volatile storage device of the application host may be stopped to remove entries associated with the application from the volatile storage device. Further, the application may be uninstalled from the non-volatile storage device. At 256, upon uninstalling the application, code of the upgraded application may be committed from the virtual upgrade layer to the non-volatile storage device and the upgraded application may be started on the application host.

FIG. 2C is a flowchart illustrating an example method 270 for deleting the virtual upgrade layer from the non-volatile storage device. At 272, a confirmation whether the upgraded application is working may be obtained from the user. At 274, a check may be made to determine whether the upgraded application is working (i.e., whether the application is successfully upgraded). When the upgraded application is not working, the application host may be reverted to a back-up data of the application, at 276. In this example, the application data may be backed-up prior to initiating the application upgrade.

When the upgraded application is working, code associated with the upgraded application may be moved from the virtual upgrade layer to the non-volatile storage device, at 278. Upon moving the code associated with the upgraded application to the non-volatile storage device, the virtual upgrade layer may be deleted from the non-volatile storage device, at 280.

Example methods 200 and 270 depicted in FIGS. 2A, 2B, and 2C, may represent generalized illustrations. Other processes may be added, or existing processes may be removed, modified, or rearranged without departing from the scope and spirit of the present application. In addition, methods 200 and 270, may represent instructions stored on a computer-readable storage medium that, when executed, may cause a processor to respond, for example, to perform actions, to change states, and/or to make decisions. Methods 200 and 270 may represent functions and/or actions performed by functionally equivalent circuits like analog circuits, digital signal processing circuits, application specific integrated circuits (ASICs), or other hardware components associated with the system. Furthermore, methods 200 and 270 are not intended to limit the implementation of the present application. Rather, example methods 200 and 270, may illustrate functional information to design/fabricate circuits, generate computer-readable instructions, or use a combination of hardware and computer-readable instructions to perform the illustrated processes.

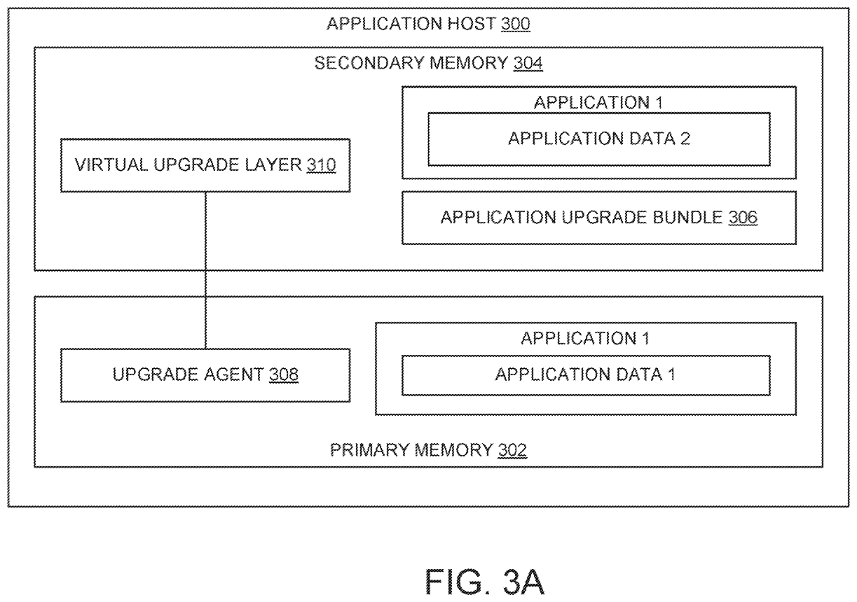

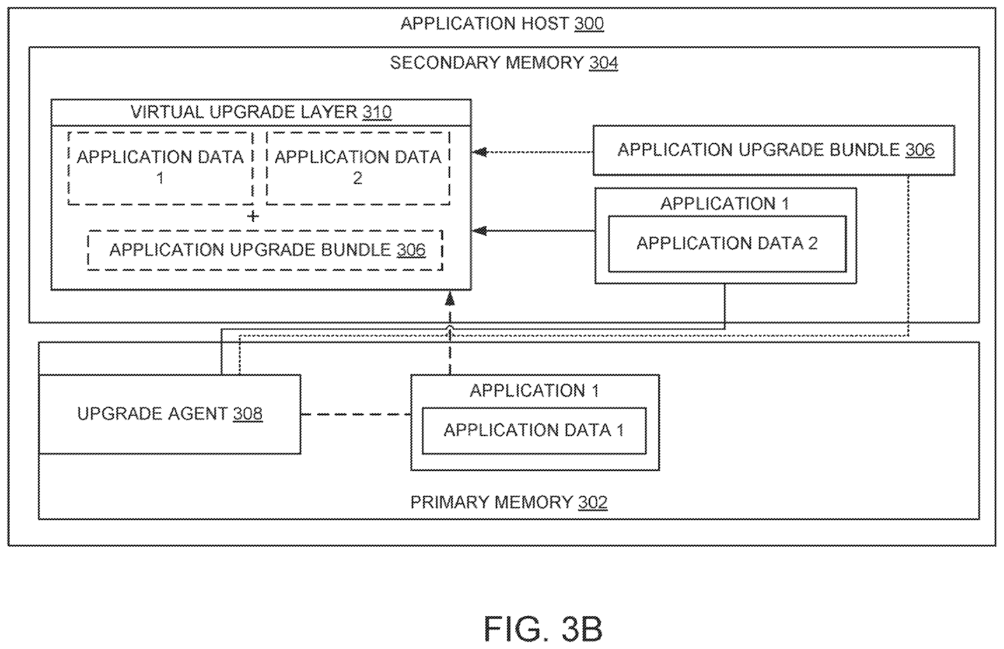

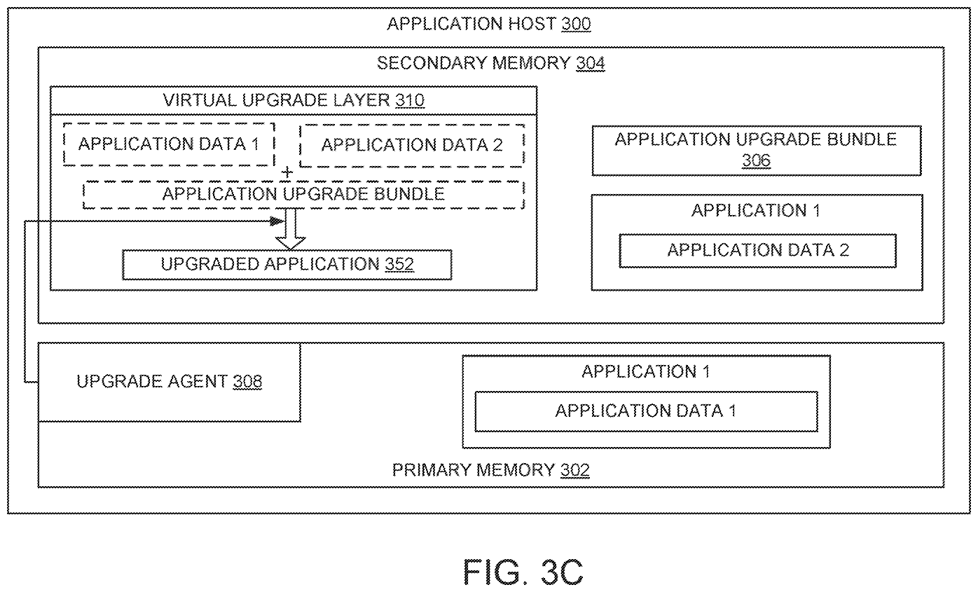

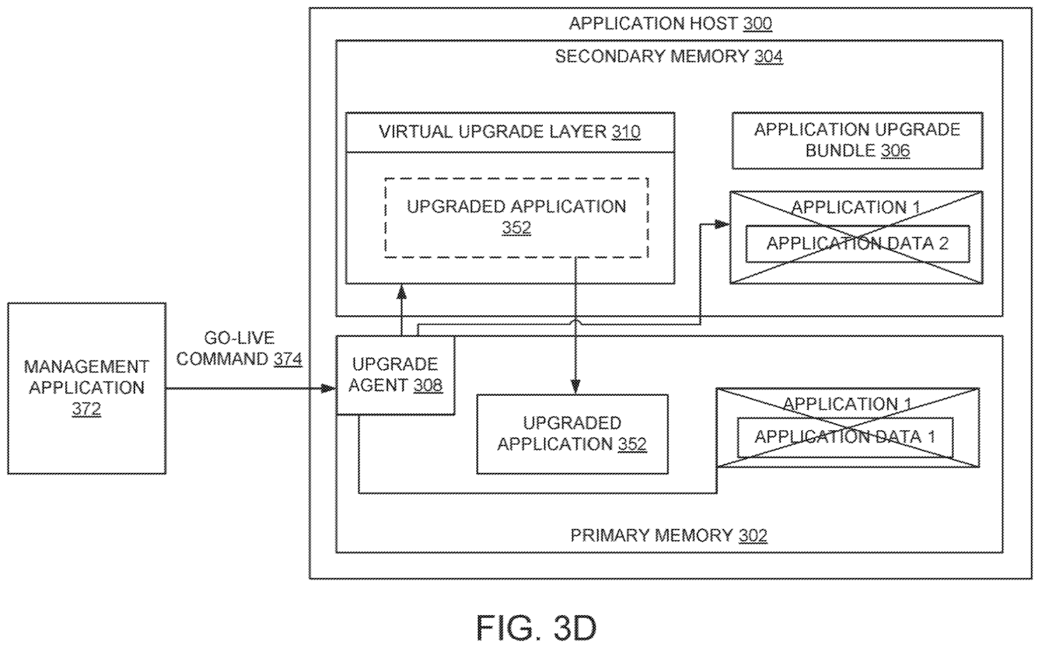

FIGS. 3A-3D are schematic block diagrams of an example application host 300, illustrating a sequence of operations for upgrading an application (e.g., an Application 1). As shown in FIGS. 3A-3D, application host 300 may include a primary memory 302 (e.g., a RAM) and a secondary memory 304 (e.g., a hard disk). Further, application host 300 may execute an application (e.g., Application 1). Furthermore, Application 1 may include application data (e.g., Application Data 1, Application Data 2, and the like) of Application 1 stored in primary memory 302 and secondary memory 304. As shown in FIG. 3A, an application upgrade bundle 306 to upgrade Application 1 may be pushed onto application host 300 that requires an application upgrade. Application upgrade bundle 306 may be stored in secondary memory 304. Upon receiving application upgrade bundle 306, an upgrade agent 308 may be installed and executed in primary memory 302 of application host 300. Upgrade agent 308, when executed, may create a virtual upgrade layer 310 in secondary memory 304.

As shown in FIG. 3B, upgrade agent 308, when executed, may copy application files (e.g., Application Data 1 and Application Data 2) from primary memory 302 and secondary memory 304 to virtual upgrade layer 310. Furthermore, upgrade agent 308, when executed, may copy application upgrade bundle 306 from secondary memory 304 to virtual upgrade layer 310.

As shown in FIG. 3C, when all the application files of Application 1 are copied, upgrade agent 308 may upgrade Application 1 in virtual upgrade layer 310 as a background process using application upgrade bundle 306 and application files that are copied to virtual upgrade layer 310. In an example, an upgraded application 352 is shown in virtual upgrade layer 310.

As shown in FIG. 3D, when the upgrading of Application 1 is completed, upgrade agent 308 may receive a go-live command 374 from a management application 372. In response to receiving go-live command 374, upgrade agent 308 may halt Application 1 running in primary memory 302 and uninstall Application 1 from secondary memory 304 (i.e., remove entries corresponding to Application 1). Further, upgrade agent 308 may move upgraded application 352 from virtual upgrade layer 310 to secondary memory 304 and start running upgraded application 352 in primary memory 302.

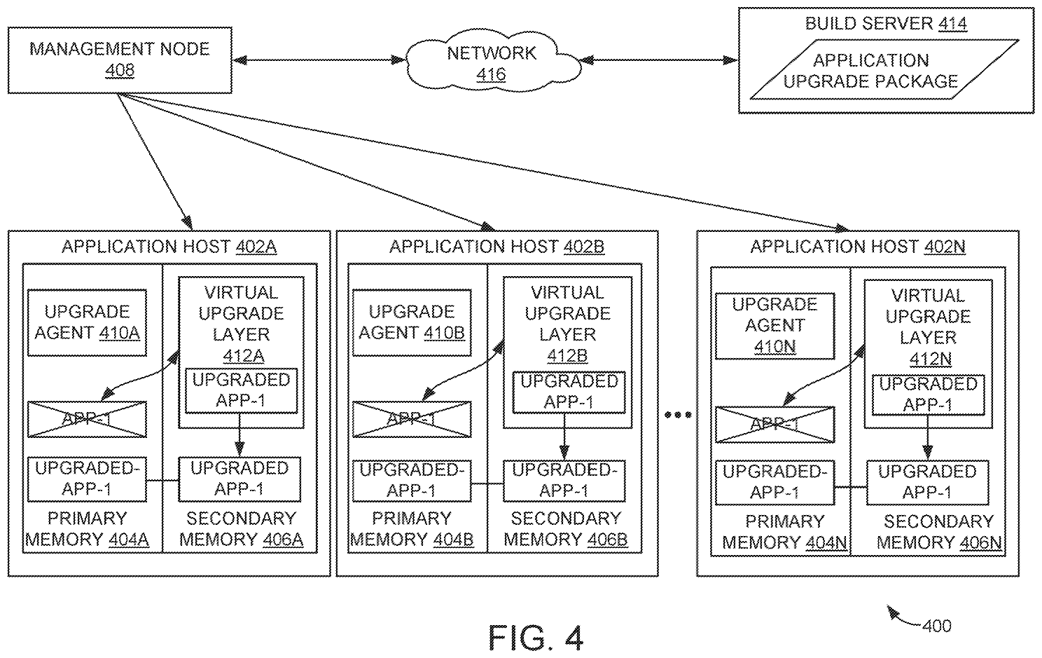

FIG. 4 is a schematic block diagram of an example system 400, depicting a management node 408 to upgrade an application (e.g., an Application 1) on a plurality of application hosts 402A-402N (e.g., production servers). As shown in FIG. 4, system 400 may include plurality of application hosts 402A-402N and management node 408 connected to plurality of application hosts 402A-402N. Further, application hosts 402A-402N may include respective primary memory 404A-404N and respective secondary memory 406A-406N. Further, application hosts 402A-402N may execute an application (e.g., Application 1).

Upon receiving a request to upgrade application 1, management node 408 may push an application upgrade package from a build server 414 to application hosts 402A-402N via a network 416. Further, management node 408 may install upgrade agents 410A-410N in application hosts 402A-402N requiring an upgrade of Application 1. Further, management node 408 may execute upgrade agents 410A-410N to:
create virtual upgrade layers 412A-412N in secondary memory 406A-406N, respectively.
copy the application upgrade packages and application data associated with Application 1 to respective virtual upgrade layers 412A-412N.
upgrade Application 1 in virtual upgrade layers 412A-412N using the application upgrade package and the application data (e.g., the upgrade may run in background without affecting existing workloads/applications as the changes are not committed to primary memory 404A-404N and secondary memory 406A-406N). The upgrade of Application 1 may be performed in virtual upgrade layers 412A-412N either in series, parallel, or in any combinations.
once “virtual upgrade layer with upgraded Application 1” is ready to go-live on all application hosts 402A-402N, a go-live command may be invoked to commit the upgraded application from virtual upgrade layers 412A-412N to secondary memory 406A-406N, respective, and start upgraded Application 1 in application hosts 402A-402N (e.g., as explained with respect to FIGS. 3A-3D).

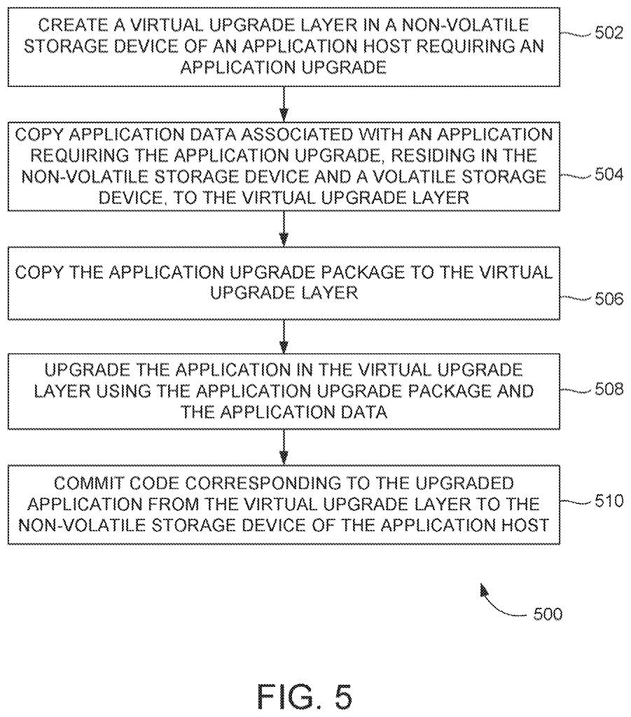

FIG. 5 is a flowchart illustrating an example method 500 for upgrading an application in an application host. Example method 500 depicted in FIG. 5, may represent generalized illustrations. Other processes may be added, or existing processes may be removed, modified, or rearranged without departing from the scope and spirit of the present application. In addition, the method 500, may represent instructions stored on a computer-readable storage medium that, when executed, may cause a processor to respond, for example, to perform actions, to change states, and/or to make decisions. Method 500 may represent functions and/or actions performed by functionally equivalent circuits like analog circuits, digital signal processing circuits, application specific integrated circuits (ASICs), or other hardware components associated with the system. Furthermore, method 500, is not intended to limit the implementation of the present application. Rather, example method 500, may illustrate functional information to design/fabricate circuits, generate computer-readable instructions, or use a combination of hardware and computer-readable instructions to perform the illustrated processes.

At 502, a virtual upgrade layer may be created in a non-volatile storage device of an application host requiring an application upgrade. In an example, the application host may include a physical host computing device or a virtual machine running on the physical host computing device.

At 504, application data associated with an application requiring the application upgrade, residing in the non-volatile storage device and a volatile storage device, may be copied to the virtual upgrade layer.

At 506, the application upgrade package may be copied to the virtual upgrade layer. In an example, copying the application upgrade package to the virtual upgrade layer may include:
receiving the application upgrade package to upgrade the application from a server,
storing the application upgrade package in the non-volatile storage device, and
upon creating the virtual upgrade layer, copying the application upgrade package from the non-volatile storage device to the virtual upgrade layer.

At 508, the application in the virtual upgrade layer may be upgraded using the application upgrade package and the application data. In an example, upgrading the application in the virtual upgrade layer may include upgrading the application in the virtual upgrade layer of the application host as a background process while the application is running in the application host.

At 510, in response to receiving a go-live command, code corresponding to the upgraded application may be committed from the virtual upgrade layer to the non-volatile storage device of the application host. In an example, committing the code corresponding to the upgraded application from the virtual upgrade layer to the non-volatile storage device may include:
halting the application running in a volatile storage device of the application host;
uninstalling the application from the non-volatile storage device,
moving the upgraded application from the virtual upgrade layer to the non-volatile storage device; and
executing the upgraded application in the volatile storage device.

Further, method 500 may include outputting a prompt seeking user confirmation to determine a working status of the upgraded application. Further, when the upgraded application is working, deleting the virtual upgrade layer from the non-volatile storage device.

Furthermore, method 500 may include generating a pre-upgrade snapshot of the application in the application host prior to creating the virtual upgrade layer. In an example, when the upgraded application is not working, the application host may be reverted to the pre-upgrade snapshot of the application.

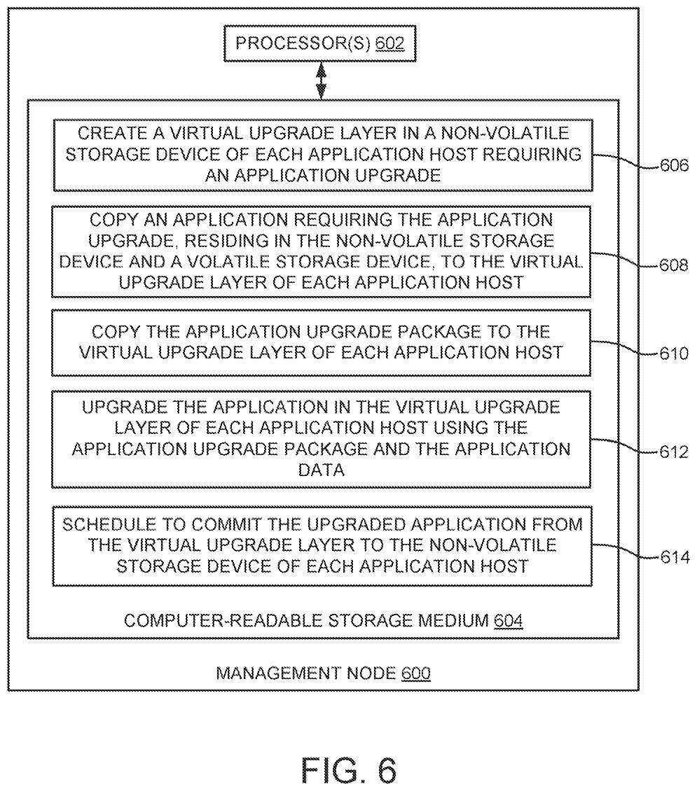

FIG. 6 is a block diagram of an example management node 600 including a non-transitory computer-readable storage medium 604 storing instructions to upgrade an application in each of a plurality of application hosts. Further, management node 600 may include a processor 602 and computer-readable storage medium 604 communicatively coupled through a system bus. Processor 602 may be any type of central processing unit (CPU), microprocessor, or processing logic that interprets and executes computer-readable instructions stored in computer-readable storage medium 604. Computer-readable storage medium 604 may be a random-access memory (RAM) or another type of dynamic storage device that may store information and computer-readable instructions for execution by processor 602. For example, computer-readable storage medium 604 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 604 may be a non-transitory computer-readable medium. In an example, computer-readable storage medium 604 may be remote but accessible to management node 600.

Computer-readable storage medium 604 may store instructions 606, 608, 610, 612, and 614. Instructions 606 may be executed by processor 602 to create a virtual upgrade layer in a non-volatile storage device of each application host requiring an application upgrade. Instructions 608 may be executed by processor 602 to copy an application requiring the application upgrade, residing in the non-volatile storage device and a volatile storage device, to the virtual upgrade layer of each application host. Instructions 610 may be executed by processor 602 to copy the application upgrade package to the virtual upgrade layer of each application host.

Instructions 612 may be executed by processor 602 to upgrade the application in the virtual upgrade layer of each application host using the application upgrade package and the application data. In an example, instructions 612 to upgrade the application in the virtual upgrade layer may include instructions to isolate the upgrading of the application to the virtual upgrade layer of each application host while the application is running in each application host.

Instructions 614 may be executed by processor 602 to schedule to commit the upgraded application from the virtual upgrade layer to the non-volatile storage device of each application host. In an example, instructions to commit the upgraded application from the virtual upgrade layer to the non-volatile storage device may include instructions to:
halt the application running in a volatile storage device of the application host;
uninstall the application from the non-volatile storage device;
move the upgraded application from the virtual upgrade layer to the non-volatile storage device, and
execute the upgraded application in the volatile storage device.

Further, computer-readable storage medium 604 may store instructions to commit the upgraded application from the virtual upgrade layer to the non-volatile storage device of each application host in accordance with the schedule.

Furthermore, computer-readable storage medium 604 may store instructions to delete the virtual upgrade layer from the non-volatile storage device upon committing the upgraded application from the virtual upgrade layer to the non-volatile storage device when upgrading of the application is successful. In another example, computer-readable storage medium 604 may store instructions to revert each application host to a pre-upgrade snapshot of the application when upgrading of the application is not successful.

Some or all of the system components and/or data structures may also be stored as contents (e.g., as executable or other computer-readable software instructions or structured data) on a non-transitory computer-readable medium (e.g., as a hard disk; a computer memory; a computer network or cellular wireless network or other data transmission medium; or a portable media article to be read by an appropriate drive or via an appropriate connection, such as a DVD or flash memory device) so as to enable or configure the computer-readable medium and/or one or more host computing systems or devices to execute or otherwise use or provide the contents to perform at least some of the described techniques.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and/or any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on,” as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A system comprising:
a plurality of application hosts with each application host executing an application; and
a management node coupled to the plurality of application hosts via a network, wherein the management node comprises an application upgrade unit to:
install an upgrade agent in each application host requiring an upgrade of the application; and
execute the upgrade agent to:
create a virtual upgrade layer in a non-volatile storage device of each application host;
copy an application upgrade package and application data associated with the application to the virtual upgrade layer;
upgrade the application in the virtual upgrade layer of each application host using the application upgrade package and the application data; and
in response to receiving a go-live command, commit the upgraded application from the virtual upgrade layer to the non-volatile storage device of each application host.

2. The system of claim 1, wherein the application upgrade unit is to:
push the application upgrade package to each application host requiring the upgrade for storing in the non-volatile storage device of each application host, wherein the upgrade agent, when executed, is to copy the application upgrade package from the non-volatile storage device to the virtual upgrade layer of each application host.

3. The system of claim 1, wherein, in response to receiving the go-live command, the upgrade agent is to:
halt the application running in a volatile storage device of each application host;
uninstall the application from the non-volatile storage device;
move the upgraded application from the virtual upgrade layer to the non-volatile storage device; and
start running the upgraded application in the volatile storage device of each application host.

4. The system of claim 1, wherein, upon committing the upgraded application from the virtual upgrade layer to the non-volatile storage device, the upgrade agent is to:
output a prompt seeking user confirmation to determine a working status of the upgraded application;
when the upgraded application is working:
move the upgraded application from the virtual upgrade layer to the non-volatile storage device; and
delete the virtual upgrade layer from the non-volatile storage device.

5. The system of claim 4, wherein the application upgrade unit is to:
generate a pre-upgrade snapshot of the application in each application host prior to installing the upgrade agent, wherein when the upgraded application is not working, the upgrade agent is to:
revert each application host to the pre-upgrade snapshot of the application.

6. The system of claim 1, wherein the upgrade agent is to:
copy the application data associated with the application requiring the upgrade, residing in the non-volatile storage device and the volatile storage device, to the virtual upgrade layer of each application host.

7. The system of claim 1, wherein the upgrade agent is to:
upgrade the application in the virtual upgrade layer of each application host as a background process while the application is running in each application host.

8. The system of claim 1, wherein each application host comprises a physical host computing device or a virtual machine.

9. A method comprising:
creating a virtual upgrade layer in a non-volatile storage device of an application host requiring an application upgrade;
copying application data associated with an application requiring the application upgrade, residing in the non-volatile storage device and a volatile storage device, to the virtual upgrade layer;
copying the application upgrade package to the virtual upgrade layer;
upgrading the application in the virtual upgrade layer using the application upgrade package and the application data; and
in response to receiving a go-live command, committing code corresponding to the upgraded application from the virtual upgrade layer to the non-volatile storage device of the application host.

10. The method of claim 9, wherein copying the application upgrade package to the virtual upgrade layer comprises:
receiving the application upgrade package to upgrade the application from a server;
storing the application upgrade package in the non-volatile storage device; and
upon creating the virtual upgrade layer, copying the application upgrade package from the non-volatile storage device to the virtual upgrade layer.

11. The method of claim 9, wherein committing the code corresponding to the upgraded application from the virtual upgrade layer to the non-volatile storage device comprises:
halting the application running in a volatile storage device of the application host;
uninstalling the application from the non-volatile storage device;
moving the upgraded application from the virtual upgrade layer to the non-volatile storage device; and
executing the upgraded application in the volatile storage device.

12. The method of claim 9, further comprising:
outputting a prompt seeking user confirmation to determine a working status of the upgraded application; and
when the upgraded application is working, deleting the virtual upgrade layer from the non-volatile storage device.

13. The method of claim 9, further comprising:
generating a pre-upgrade snapshot of the application in the application host prior to creating the virtual upgrade layer, wherein when the upgraded application is not working:
reverting the application host to the pre-upgrade snapshot of the application.

14. The method of claim 9, wherein the application host comprises a physical host computing device or a virtual machine running on the physical host computing device.

15. The method of claim 9, wherein upgrading the application in the virtual upgrade layer comprises:
upgrading the application in the virtual upgrade layer of the application host as a background process while the application is running in the application host.

16. A non-transitory computer-readable storage medium storing instructions executable by a processor of a management node to:
create a virtual upgrade layer in a non-volatile storage device of each application host requiring an application upgrade;
copy an application requiring the application upgrade, residing in the non-volatile storage device and a volatile storage device, to the virtual upgrade layer of each application host;
copy the application upgrade package to the virtual upgrade layer of each application host;
upgrade the application in the virtual upgrade layer of each application host using the application upgrade package and the application data; and
schedule to commit the upgraded application from the virtual upgrade layer to the non-volatile storage device of each application host.

17. The non-transitory computer-readable storage medium of claim 16, further comprising instructions to:
commit the upgraded application from the virtual upgrade layer to the non-volatile storage device of each application host in accordance with the schedule.

18. The non-transitory computer-readable storage medium of claim 16, wherein instructions to commit the upgraded application from the virtual upgrade layer to the non-volatile storage device comprise instructions to:
halt the application running in a volatile storage device of the application host;
uninstall the application from the non-volatile storage device;
move the upgraded application from the virtual upgrade layer to the non-volatile storage device; and
execute the upgraded application in the volatile storage device.

19. The non-transitory computer-readable storage medium of claim 16, wherein instructions to upgrade the application in the virtual upgrade layer comprising instructions to:
isolate the upgrading of the application to the virtual upgrade layer of each application host while the application is running in each application host.

20. The non-transitory computer-readable storage medium of claim 16, further comprising instructions to:
when upgrading of the application is successful, delete the virtual upgrade layer from the non-volatile storage device upon committing the upgraded application from the virtual upgrade layer to the non-volatile storage device; and
when upgrading of the application is not successful, revert each application host to a pre-upgrade snapshot of the application.
